(19) United States
(12) Patent Application Publication
(10) Pub. No.: US 2026/0281394 A1
(43) Pub. Date: Sep. 17, 2026

(54) METHODS AND APPARATUS OF LOCAL ILLUMINATION COMPENSATION WITH GAMMA ADJUSTMENT IN VIDEO CODING SYSTEM

(71) Applicant: MEDIATEK INC., Hsinchu City (TW)

(72) Inventors: Cheng-Yen CHUANG, Hsinchu City (TW); Chih-Hsuan LO, Hsinchu City (TW); Chen-Yen LAI, Hsinchu City (TW); Ching-Yeh CHEN, Hsinchu City (TW); Yi-Wen CHEN, San Jose, CA (US); Tzu-Der CHUANG, Hsinchu City (TW); Chih-Wei HSU, Hsinchu City (TW)

(21) Appl. No.: 19/472,745

(22) PCT Filed: Oct. 31, 2024
(86) PCT No.: PCT/CN2024/128743

§ 371 Date: Oct. 6, 2025

Related U.S. Application Data
(60) Provisional application No. 63/595,379, filed on Nov. 2, 2023.

(51) Int. Cl. H04N 19/186; H04N 19/105; H04N 19/107; H04N 19/172; H04N 19/176; H04N 19/182; H04N 19/196; H04N 19/503; H04N 19/593; H04N 19/70

(52) U.S. Cl. CPC H04N 19/186; H04N 19/105; H04N 19/107; H04N 19/172; H04N 19/176; H04N 19/182; H04N 19/196; H04N 19/503; H04N 19/593; H04N 19/70

(57) ABSTRACT

A method and apparatus for video coding are disclosed. According to this method, input data associated with a current block is received, wherein the input data comprises pixel data to be encoded at an encoder side or data associated with the current block to be decoded at a decoder side, wherein the current block is coded in a non-intra mode. An LIC (Local Illumination Compensation) prediction model, wherein the LIC prediction model comprises a gamma term related to an input signal and a gamma value for the gamma term is not equal to 1. The current block is encoded or decoded using coding information comprising the LIC prediction model, wherein when the LIC prediction model is selected for the current block, a predictor for the current block is generated by applying the LIC prediction model to a reference block.

### CROSS REFERENCE TO RELATED APPLICATIONS

The present invention is a non-Provisional Application of and claims priority to U.S. Provisional Patent Application No. 63/595,379, filed on Nov. 2, 2023. The U.S. Provisional Patent Application is hereby incorporated by reference in its entirety.

### FIELD OF THE INVENTION

The present invention relates to video coding system. In particular, the present invention discloses an LIC (Local Illumination Compensation) prediction mode with gamma correction to improve the performance of LIC prediction.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Partitioning of the CTUs Using a Tree Structure

In High-Efficient Video Coding standard (HEVC), pictures are divided into a sequence of coding tree units (CTUs). A CTU consists of an N×N block of luma samples together with two corresponding blocks of chroma samples for a picture that has three sample arrays, or an N×N block of samples of a monochrome plane in a picture that is coded using three separate colour planes. The CTU concept is broadly analogous to that of the macroblock in previous standards such as Advanced Video Coding (AVC). The maximum allowed size of the luma block in a CTU is specified to be 64×64 in Main profile. A CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four prediction units (PUs) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

Versatile Video Coding standard (VVC) is the successor to HEVC. In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

For each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. The reference software can be accessed via https://vcgit.hhi.fraunhofer.de/ecm/ECM.git. ECM basically is the successor to VVC and thus it shares many common parts as VVC.

### Local Illumination Compensation (LIC)

LIC is an inter prediction technique to model local illumination variation between the current block and its prediction block as a function of that between current block template and reference block template. The parameters of the function can be denoted by a scale a and an offset B, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on the current block template and reference block template, no signalling overhead is required for them, except that an LIC flag is signalled for AMVP mode to indicate the use of LIC.

The local illumination compensation proposed in JVET-00066 is used for uni-prediction inter CUs with the following modifications.
Intra neighbour samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### Bi-Predictive LIC

In the method, the LIC mode is extended to bi-predictive CUs. Specifically, two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ] ,$$

$$and$$

$${p}_{0}^{′} [ x , y ] = {α}_{0} \cdot {P}_{0} [ x , y ] + {β}_{0}$$

$${p}_{1}^{′} [ x , y ] = {α}_{1} \cdot {P}_{1} [ x , y ] + {β}_{1} ,$$

where α₀ and β₀, and α₁ and β₁ indicate the scales and the offsets in L0 and L1, respectively; ω indicates the weight (as indicated by the CU-level BCW index) for the weighted combination of L0 and L1 predictions. The same derivation scheme of the LIC mode is reused and applied in one iterative manner to derive the L0 and L1 LIC parameters. Specifically, the method firstly derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signalled for AMVP bi-predicted CUs for the indication of the LIC mode while the flag is inherited for merge related inter CUs. Additionally, the LIC is disabled when decoder-side motion vector refinement (DMVR) (including multi-pass DMVR, adaptive DMVR and affine DMVR) and bi-directional optical flow (BDOF) is applied.

OBMC with LIC

In the method, the OBMC is enabled for the inter blocks that are coded with the LIC mode and to reduce the complexity, the OBMC is only applied to the top and left CU boundaries while being always disabled for the boundaries of the internal sub-blocks of one LIC CU. Additionally, when one neighbouring block is coded with the LIC, its LIC parameters are applied to generate the corresponding prediction samples for the OBMC of one current block.

In the present invention, methods to improve the performance of LIC prediction are disclosed.

### BRIEF SUMMARY OF THE INVENTION

A method and apparatus for video coding are disclosed. According to this method, input data associated with a current block is received, wherein the input data comprises pixel data to be encoded at an encoder side or data associated with the current block to be decoded at a decoder side, wherein the current block is coded in a non-intra mode. An LIC (Local Illumination Compensation) prediction model, wherein the LIC prediction model comprises a gamma term related to an input signal and a gamma value for the gamma term is not equal to 1. The current block is encoded or decoded using coding information comprising the LIC prediction model, wherein when the LIC prediction model is selected for the current block, a predictor for the current block is generated by applying the LIC prediction model to a reference block.

In one embodiment, one or more parameters of the LIC prediction model are derived by performing a regression-based process on a neighbouring template region of the current block.

In one embodiment, one or more parameters of the LIC prediction model are derived by performing a two-stage regression-based process, and wherein a first-stage regression process treats the gamma term with the gamma value set to 1 to derive other parameters and a second-stage regression process fixes the other parameters determined in the first-stage regression process to derive the gamma value.

In one embodiment, the gamma term is converted to a Taylor series, and only first N terms in the Taylor series are included in the LIC prediction model for simplification, and wherein N is a positive integer larger than 0. In another embodiment, the gamma value corresponds to a pre-defined constant value, and the gamma term is implemented by using a lookup table.

In one embodiment, the LIC prediction model comprises two gamma terms with two pre-defined constant gamma values. In one embodiment, first gamma term has a first pre-defined constant gamma value smaller than 1, and a second gamma term has a second pre-defined constant gamma value greater than 1.

In one embodiment, the LIC prediction model comprises M gamma terms with gamma values smaller than 1 and N gamma terms with gamma values greater than 1, and wherein M and N are positive integers.

In one embodiment, a CU level flag is signalled or parsed to indicate whether the LIC prediction model with gamma term is used for the current block or not, and wherein the CU level flag is located after an LIC flag.

In one embodiment, multiple LIC prediction models with different gamma values are available and a CU level flag is signalled or parsed to indicate which one of the multiple LIC prediction models is used for the current block, and wherein the CU level flag is located after an LIC flag. In one embodiment, a high-level syntax is signalled or parsed to indicate target gamma values used in the multiple LIC prediction models.

In one embodiment, the LIC prediction model is applied to a reference frame to generate a gamma corrected reference frame. In one embodiment, a CU-level flag is signalled or parsed to indicate whether the gamma corrected reference frame is selected for the current block. In one embodiment, the gamma corrected reference frame is always selected for the current block. In one embodiment, selection between the reference frame and the gamma corrected reference frame is determined according to template matching cost. In one embodiment, the gamma value used in the gamma corrected reference frame is directly signalled or parsed in a high-level syntax.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 shows an example of a CTU divided into multiple CUs with a quadtree and nested multi-type tree coding block structure, where the bold block edges represent quadtree partitioning and the remaining edges represent multi-type tree partitioning.

FIG. 4 illustrates a flowchart of an exemplary video coding system that incorporates LIC process with gamma correction according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In this invention, LIC prediction with gamma correction are disclosed to improve the performance of LIC prediction.

LIC Improvement with Gamma Correction

Gamma correction is a nonlinear operation used to encode and decode luminance or tri-stimulus values in video or still image systems. Gamma correction is, in the simplest cases, defined by the following expression:

$${V}_{out} = a * {V}_{in}^{γ}$$

where the non-negative real input value Vᵢₙ is raised to the power of γ and multiplied by the constant α to get the output value Vₒᵤₜ.

The assumption used in LIC is that there may be a linear relationship between samples of the current block and the samples of the reference block in another frame. However, in digital imaging system, the actual exposure of light is encoded into a digital value by the Gamma operation. The linear relationship between samples in different frames may exist before the Gamma operation rather than after the Gamma operation. Therefore, the current linear model used in LIC may not accurately formulate the relationship between samples in different frames.

Several methods are proposed in this disclosure to further improve the accuracy of LIC model.

### Gamma Term in LIC Model

In one embodiment, a new gamma term G(x) is proposed to be used in the LIC model. The input x of the gamma term can be the collocated reference sample, and the γ can be a variable which will be derived by performing regression-based methods on the neighbouring template region.

$$G ( x ) = {x}^{γ}$$

In one embodiment, the LIC model can further contain the gamma term as the following formula. The gamma term has a variable γ. The optimal parameters c₀, c₁, c₂ and γ can be derived by performing regression-based methods on the neighbouring template region.

$$pred = {c}_{0} x + {c}_{1} {x}^{γ} + {c}_{2} B$$

In another embodiment, the gamma term can be converted to a Taylor series, and then only the first N terms in the Taylor series are included in the LIC model for simplification, where N is a positive integer larger than 0.

In another embodiment, the output of the original LIC model can be the input of the gamma term as the following formula. A two-stage regression method can be used to derive the optimal parameter c₀, c₁ and γ. In the first stage, the gamma value γ can be temporarily ignored (set to 1), and the remaining parameters c₀ and c₁ are solved by the regression. In the second stage, c₀ and c₁ are fixed, and the gamma value γ is solved by a regression method:

$$pred = {( {c}_{0} x + {c}_{1} B )}^{γ} .$$

Since there is only one parameter γ in the second round that needs to be derived, the regression process can be simplified into the following formula, and the logarithmic operation and the division operation can be replaced by a lookup table method.

$$γ = \frac{log ( pred )}{log ( {c}_{0} x + {c}_{1} B )}$$

In one embodiment, the γ in the gamma term can be a pre-defined constant real value, and the operation of the gamma term with the constant γ can be implemented through a lookup table.

In one embodiment, the LIC model can further contain two gamma terms with two pre-defined constant gamma values as the following formula. One of the gamma terms has a pre-defined constant gamma value γ₁ smaller than 1, and the other has a pre-defined constant gamma value γ₂ greater than 1. For example, γ₁ can be 0.9 and γ₂ can be 1.1. The optimal parameters c₀, c₁, c₂ and c₃ are derived by performing regression-based methods on the neighbouring template region.

$$pred = {c}_{0} x + {c}_{1} {x}^{{γ}_{1}} + {c}_{2} {x}^{{γ}_{2}} + {c}_{3} B .$$

In another embodiment, the LIC model can further contain multiple gamma terms with pre-defined constant gamma values. There are M gamma terms with pre-defined constant gamma values smaller than 1, and there are N gamma terms with pre-defined constant gamma values greater than 1, where M and N are positive integer values larger than 0.

In one embodiment, a CU level flag can be signalled after the LIC flag to indicate whether the LIC model with gamma term is used for the current block or not.

In another embodiment, there can be multiple LIC models, and some of them have different types of gamma term. A CU level index can be signalled after the LIC flag to indicate which LIC model is used for the current block.

In another embodiment, a high-level syntax can be signalled to indicate the gamma values used in the LIC model.

### Frame-Level Gamma Correction

In one embodiment, a frame-level gamma correction method is proposed. In addition to the reference frame, gamma corrected reference frame can also be selected. The gamma corrected reference frame is derived by applying gamma correction on the reference frame as the following formula:

$${frame}^{′} = G ( frame )$$

In one embodiment, a CU-level flag can be signalled to indicate whether the selected reference frame is gamma corrected or not.

In another embodiment, the gamma corrected reference frame is always selected.

In another embodiment, the selection between the reference frame and the gamma corrected reference frame is determined according to the template matching cost.

In one embodiment, the gamma value γ used in the gamma corrected frame can be directly signalled in the high-level syntax.

In another embodiment, a gamma value index can be signalled in the high-level syntax, and the gamma value γ used in the gamma corrected frame is selected from a pre-defined gamma value list according to the signalled gamma value index.

In one embodiment, the gamma correction can be always applied to the reconstructed frame.

In another embodiment, a CU-level flag can be signalled to indicate whether the gamma correction is applied to the reconstructed samples of the current block or not.

### LIC Template Pre-Processing

In one embodiment, before the LIC model derivation process, a low-pass filter can be applied to samples in the template region to reduce the impact of outliers.

In one embodiment, both the template region of the current block and the template region of the reference block can apply the low-pass filter.

In another embodiment, only the template region of the current block can apply the low-pass filter.

In another embodiment, only the template region of the reference block can apply the low-pass filter.

In one embodiment, a two-dimensional low-pass filter can be used for smoothing the samples in template region. For example, two-dimensional filters as shown in the following equation can be used:

$${F}_{1} = [ \begin{matrix}0 & 1 & 0 \\ 1 & 4 & 1 \\ 0 & 1 & 0\end{matrix} ] , {F}_{2} = [ \begin{matrix}1 & 1 & 1 \\ 1 & 8 & 1 \\ 1 & 1 & 1\end{matrix} ] , {F}_{3} = [ \begin{matrix}1 & 2 & 1 \\ 2 & 4 & 2 \\ 1 & 2 & 1\end{matrix} ] .$$

In another embodiment, one horizontal one-dimensional low-pass filter can be used for smoothing the samples in the template region. For example, horizontal one-dimensional filters as shown in the following equation can be used:

$${F}_{4} = [ \begin{matrix}1 & 2 & 1\end{matrix} ] .$$

In another embodiment, one vertical one-dimensional low-pass filter can be used for smoothing the samples in the template region. For example, vertical one-dimensional filters as shown in the following equation can be used:

$${F}_{5} = [ \begin{matrix}1 \\ 2 \\ 1\end{matrix} ]$$

In another embodiment, two one-dimensional low-pass filters can be used for smoothing the samples in template region. A horizontal one-dimensional low-pass filter can be applied first, and then followed by a vertical one-dimensional low-pass filter.

In another embodiment, two one-dimensional low-pass filters can be used for smoothing the samples in template region. A vertical one-dimensional low-pass filter can be applied first, and then followed by a horizontal one-dimensional low-pass filter.

In another embodiment, MV of the current block can be used to determine the low-pass filter. For example, if the horizontal component of the MV of the current block is larger than a certain value, horizontal one-dimensional low-pass filter is used. For another example, if the horizontal component of the MV of the current block is larger than a certain value, vertical one-dimensional low-pass filter is used. For another example, if the vertical component of the MV of the current block is larger than a certain value, vertical one-dimensional low-pass filter is used. For another example, if the vertical component of the MV of the current block is larger than a certain value, horizontal one-dimensional low-pass filter is used. For another example, if the horizontal and vertical component of the MV of the current block are both smaller than a certain value, a two-dimensional low-pass filter is used.

In one embodiment, a CU level flag can be signalled to indicated whether the template smoothing method is used before LIC model derivation or not.

In one embodiment, a CU level index can be signalled to indicated which kind of low-pass filter is used before LIC model derivation. For example, if the index is equal to the first value, two-dimensional low-pass filter is used. If the index is equal to the second value, horizontal one-dimensional low-pass filter is used. If the index is equal to the third value, vertical one-dimensional low-pass filter is used.

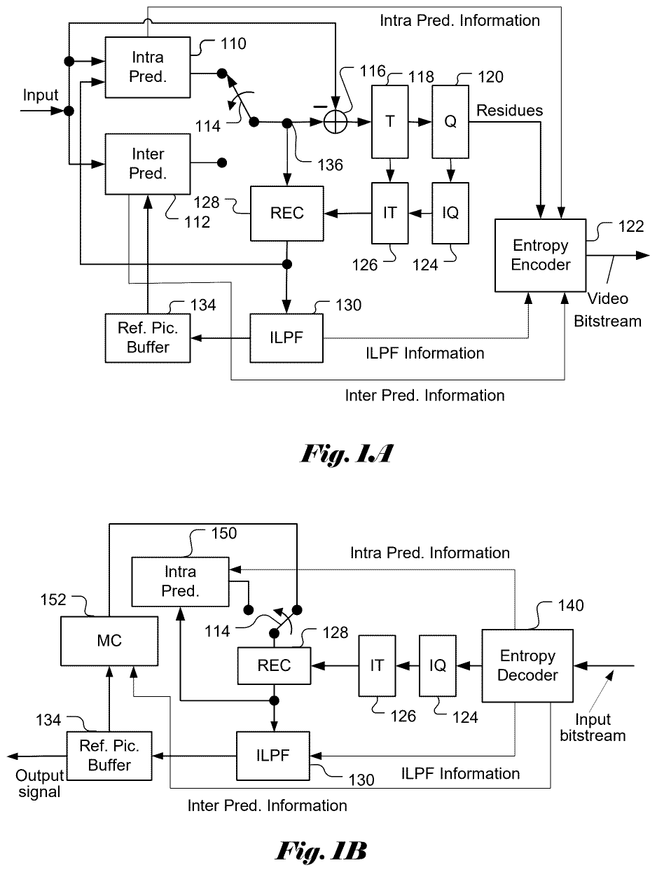

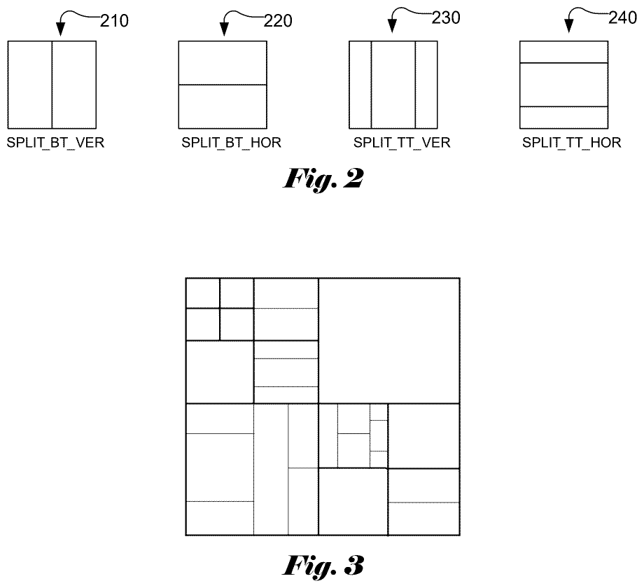

Any of the foregoing proposed methods LIC with gamma correction can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module. With reference to the encoder and decoder in FIG. 1A and FIG. 1B, any of the proposed methods can be implemented in an inter/intra/prediction/transform module (e.g. Intra Pred. 110 in FIG. 1A) of an encoder, and/or an inter/intra/prediction/transform module (e.g. Intra Pred. 150 in FIG. 1B) of a decoder.

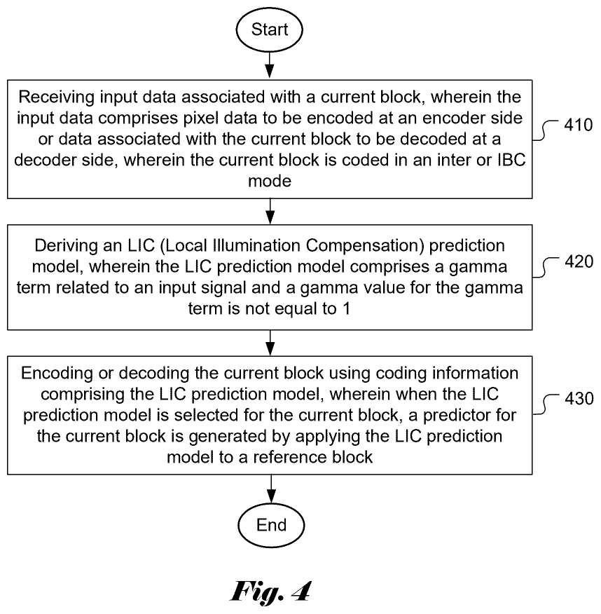

FIG. 4 illustrates a flowchart of an exemplary video coding system that incorporates LIC process with gamma correction according to an embodiment of the present invention. The steps shown in the flowchart may be implemented as program codes executable on one or more processors (e.g., one or more CPUs) at the encoder side and/or decoder side. The steps shown in the flowchart may also be implemented based hardware such as one or more electronic devices or processors arranged to perform the steps in the flowchart. According to this method, input data associated with a current block is received in step 410, wherein the input data comprises pixel data to be encoded at an encoder side or data associated with the current block to be decoded at a decoder side, wherein the current block is coded in a non-intra mode. An LIC (Local Illumination Compensation) prediction model is derived in step 420, wherein the LIC prediction model comprises a gamma term related to an input signal and a gamma value for the gamma term is not equal to 1. The current block is encoded or decoded using coding information comprising the LIC prediction model in step 430, wherein when the LIC prediction model is selected for the current block, a predictor for the current block is generated by applying the LIC prediction model to a reference block.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side, wherein the current block is coded in an inter or IBC mode;
deriving an LIC (Local Illumination Compensation) prediction model, wherein the LIC prediction model comprises a gamma term related to an input signal and a gamma value for the gamma term is not equal to 1; and
encoding or decoding the current block using coding information comprising the LIC prediction model, wherein when the LIC prediction model is selected for the current block, a predictor for the current block is generated by applying the LIC prediction model to a reference block.

2. The method of claim 1, wherein one or more parameters of the LIC prediction model are derived by performing a regression-based process on a neighbouring template region of the current block.

3. The method of claim 1, wherein one or more parameters of the LIC prediction model are derived by performing a two-stage regression-based process, and wherein a first-stage regression process treats the gamma term with the gamma value set to 1 to derive other parameters and a second-stage regression process fixes the other parameters determined in the first-stage regression process to derive the gamma value.

4. The method of claim 1, wherein the gamma term is converted to a Taylor series, and only first N terms in the Taylor series are included in the LIC prediction model for simplification, and wherein N is a positive integer larger than 0.

5. The method of claim 1, wherein the gamma value corresponds to a pre-defined constant value.

6. The method of claim 5, wherein the gamma term is implemented by using a lookup table.

7. The method of claim 1, wherein the LIC prediction model comprises two gamma terms with two pre-defined constant gamma values.

8. The method of claim 7, wherein a first gamma term has a first pre-defined constant gamma value smaller than 1, and a second gamma term has a second pre-defined constant gamma value greater than 1.

9. The method of claim 1, wherein the LIC prediction model comprises M gamma terms with gamma values smaller than 1 and N gamma terms with the gamma values greater than 1, and wherein M and N are positive integers.

10. The method of claim 1, wherein a CU level flag is signalled or parsed to indicate whether the LIC prediction model with the gamma term is used for the current block or not, and wherein the CU level flag is located after an LIC flag.

11. The method of claim 1, wherein multiple LIC prediction models with different gamma values are available and a CU level flag is signalled or parsed to indicate which one of the multiple LIC prediction models is used for the current block, and wherein the CU level flag is located after an LIC flag.

12. The method of claim 11, wherein a high-level syntax is signalled or parsed to indicate target gamma values used in the multiple LIC prediction models.

13. The method of claim 1, wherein the LIC prediction model is applied to a reference frame to generate a gamma corrected reference frame.

14. The method of claim 13, wherein a CU-level flag is signalled or parsed to indicate whether the gamma corrected reference frame is selected for the current block.

15. The method of claim 13, wherein the gamma corrected reference frame is always selected for the current block.

16. The method of claim 13, wherein selection between the reference frame and the gamma corrected reference frame is determined according to template matching cost.

17. The method of claim 13, wherein the gamma value used in the gamma corrected reference frame is directly signalled or parsed in a high-level syntax.

18. An apparatus for video coding, the apparatus comprising one or more electronics or processors arranged to:
receive input data associated with a current block, wherein the input data comprises pixel data to be encoded at an encoder side or data associated with the current block to be decoded at a decoder side, wherein the current block is coded in an inter or IBC mode;
derive an LIC (Local Illumination Compensation) prediction model, wherein the LIC prediction model comprises a gamma term related to an input signal and a gamma value for the gamma term is not equal to 1; and
encode or decode the current block using coding information comprising the LIC prediction model, wherein when the LIC prediction model is selected for the current block, a predictor for the current block is generated by applying the LIC prediction model to a reference block.
